(19) United States
(12) Patent Application Publication
(10) Pub. No.: US 2009/0174130 A1
(43) Pub. Date: Jul. 9, 2009

(54) Apparatus and method for attaching vane to shaft

(76) Inventors: Christopher A. Kozlik, Schaumburg, IL (US); Michael M. Czemske, Lyons, IL (US); Greg Smith, Geneva, IL (US)

Correspondence Address: Douglas H. Pauley;Pauley Petersen & Erickson, Suite 365, 2800 West Higgins Road, Hoffman Estates, IL, 60169, US

(21) Appl. No.: 12/006,927

(22) Filed: Jan. 7, 2008

(51) Int. Cl. B25B 1/20

(52) U.S. Cl. 269/38

(57) ABSTRACT

An apparatus and method for attaching a vane with respect to a shaft of an arrow or a crossbow bolt. The vane is attached to a sleeve that is positionable over an outer surface of the shaft. The sleeve has an inner surface and the shaft has an outer surface. In an attached position of the vane with respect to the shaft, an adhesive, such as a phase change adhesive, is positioned between and contacts at least a portion of the inner surface of the sleeve and at least a portion of the outer surface of the shaft.

### BACKGROUND OF THE INVENTION

1. Field of the Invention

This invention relates to an apparatus and a method for securing a vane, such as an archery vane or a crossbow vane, to a shaft, such as an arrow shaft or a crossbow shaft.

2. Discussion of Related Art

Known production methods for securing or attaching an archery vane to an arrow shaft can be time-consuming and expensive. When an archery vane is detached from an arrow shaft, it is difficult for an archer to repair or replace one or more archery vanes, particularly when each vane is precisely positioned with respect to each other or with respect to a longitudinal axis of the arrow shaft.

In order to maintain arrow dynamic flight characteristics of an archery arrow, it is important to maintain the precise position of the archery vane with respect to the arrow shaft. Thus, fletching systems or cartridges have been developed to simplify assembly in both the field and in the manufacturing facility.

For example, Czemske et al., U.S. Pat. No. 7,074,143 discloses a fletching system that has a sleeve which can be positioned about an outer surface of an arrow shaft, wherein at least one archery vane is mounted to an outer surface of the sleeve. The sleeve can have shrink-fit characteristics that allow the sleeve to shrink, for example when heat is applied to the sleeve. The sleeve can also be adhesively secured to the arrow shaft.

One problem with some heat shrinkable materials is that they have a relatively low coefficient of friction. For aerodynamic reasons, many arrow shafts have an outer surface with a relatively low coefficient of friction. Even if the heat shrinkable material is tightly shrunk about an outer surface of the arrow shaft, because the sleeve and the shaft each has a relatively low coefficient of friction, the sleeve can still move relative to the arrow shaft when a force is applied. For example, an archer will often grasp and pull the fletching when removing an arrow from a target. Often, the pulling force will cause the vane assembly or sleeve to pull away from the arrow shaft, leaving the arrow shaft and the arrowhead in the target and undesirably separating the sleeve and vanes from the arrow shaft.

In attempts to overcome this problem, it is known to apply an adhesive or a glue between an inner surface of the sleeve and an outer surface of the arrow shaft. However, many glues are unable to withstand the forces applied when an archer removes an arrow shaft from a target. Even with an adhesive or glue, the fletching system undesirably separates from the arrow shaft.

### SUMMARY OF THE INVENTION

It is one object of this invention to provide an apparatus and a method for securing a fletching system or sleeve with respect to an arrow shaft.

The above and other objects of this invention can be accomplished with a phase change adhesive or another suitable phase change material that is positioned between an inner surface of the sleeve and an outer surface of the arrow shaft. The phase change adhesive can provide a relatively high bonding strength or a sufficient bond between the sleeve and the arrow shaft, particularly when a surrounding environment is within a set range of temperatures. The bonding strength of the phase change adhesive can be selected or designed to withstand undesirable forces applied, for example when an archer removes an arrow from a target.

When removing or changing a fletching system, the phase change adhesive can be heated, for example, to above a set range of temperatures, to lessen the bonding strength of the adhesive between the sleeve and the arrow shaft. Thus, an archer can simply heat and then remove a fletching system or sleeve from the arrow shaft, particularly so that one or more vanes can be replaced while reusing the arrow shaft.

The phase change adhesive can also better resist relatively cold temperatures, particularly at which other adhesives or glues become brittle and/or easily lose adhesive properties. With a fletching system according to this invention, an archer can conveniently and quickly remove and replace a damaged or otherwise undesired fletching system from the arrow shaft.

### BRIEF DESCRIPTION OF THE DRAWINGS

The drawings show different features of this invention, wherein:

FIG. 1 is a side view of an aft end portion of an arrow shaft having a fletching system secured about the arrow shaft, according to one embodiment of this invention;

FIG. 2 is a side view of a fletching system, according to one embodiment of this invention;

FIG. 3 is a front view of the fletching system as shown in FIG. 2;

FIG. 4 is a sectional view taken through a section of a fletching system, according to one embodiment of this invention; and

FIG. 5 is a sectional view, taken along line 5-5, as shown in FIG. 4.

### DETAILED DESCRIPTION OF THE INVENTION

Many features and elements of this invention are similar to and further described by Czemske et al., U.S. Pat. No. 7,074,143. The entire teachings of U.S. Pat. No. 7,074,143 are incorporated into this specification by reference to U.S. Pat. No. 7,074,143.

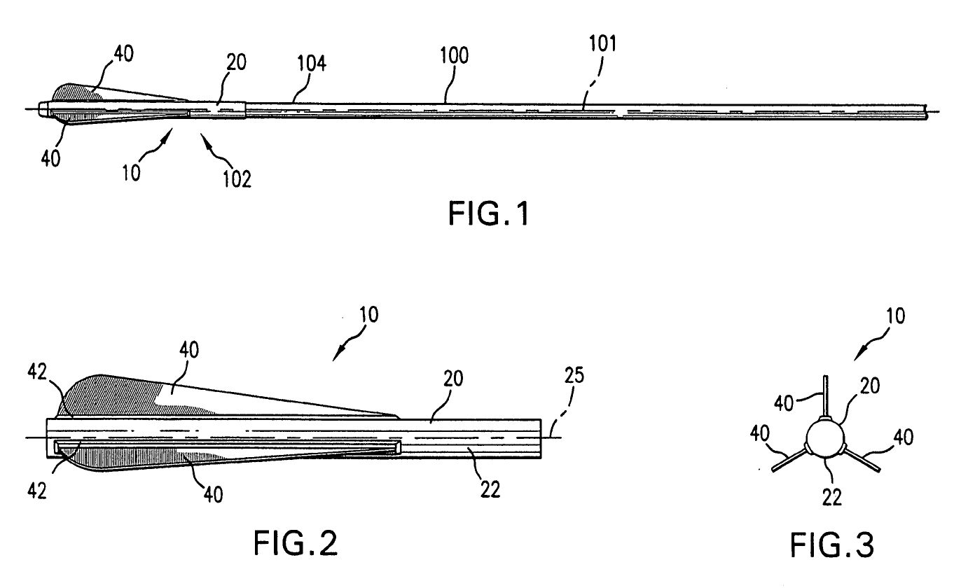

FIG. 1 shows fletching system 10 which comprises sleeve 20 that is positionable about outer surface 104 of arrow shaft 100. Fletching system 10 and/or vane 40 of this invention can be used with an archery arrow or with a crossbow bolt. In some embodiments of this invention, sleeve 20 is made of a heat shrinkable material or another similar material. Thus, sleeve 20 can be positioned relative to arrow shaft 100 and then heat can be applied to sleeve 20 to secure sleeve 20 with respect to arrow shaft 100. Further details of the apparatus and method associated with this structural arrangement are similar to those taught by U.S. Pat. No. 7,074,143.

U.S. Pat. No. 7,074,143 further teaches that sleeve 20 can be adhesively secured to arrow shaft 100. However, some heat shrinkable materials have a relatively low coefficient of friction and thus when used in combination with arrow shaft 100 having a relatively low coefficient of friction, sleeve 20 can undesirably slide, rotate or otherwise move with respect to arrow shaft 100.

To overcome the undesirable movement, it is known to position a glue or an adhesive between inner surface 21 of sleeve 20 and outer surface 104 of shaft 100. However, some conventional adhesives have such a high bonding strength that an adhesive bond cannot be broken to release fletching system 10 or sleeve 20, for example to replace a damaged or worn vane 40. Other conventional adhesives become brittle or otherwise fail in extreme weather conditions, including relatively cold environments and relatively wet or dry environments.

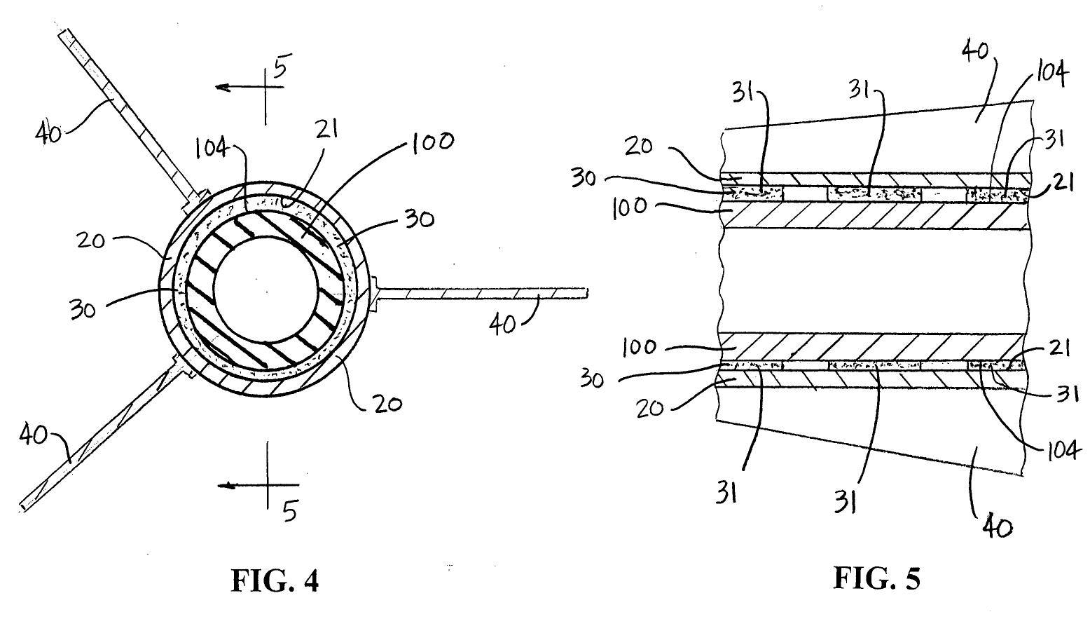

FIG. 3 shows fletching system 10 in an unattached or disassembled state, with respect to shaft 100. FIGS. 4 and 5 show fletching system 10 in an attached or assembled state, with respect to shaft 100.

As shown in FIGS. 4 and 5, sleeve 20 is mounted about outer surface 104 of shaft 100. In the attached position of vane 40 with respect to shaft 100, such as shown in FIGS. 4 and 5, phase change adhesive 30 can be positioned between inner surface 21 of sleeve 20 and outer surface 104 of shaft 100. FIG. 5 shows phase change adhesive 30 contacting at least a portion of inner surface 21 and at least a portion of outer surface 104. FIG. 5 shows phase change adhesive 30 forming a plurality of contact areas 31, which in some embodiments are separated from each other. FIG. 5 shows each contact area forming band 31 of material of phase change adhesive 30 between the spaces.

As shown in FIGS. 4 and 5, phase change adhesive 30 forms a layer between inner surface 21 and outer surface 104. In certain embodiments of this invention, the layer can be positioned about a periphery of outer surface 104 of shaft 100. In some embodiments of this invention, phase change adhesive 30 comprises any suitable material that changes its physical state, such as a function of different temperatures. U.S. Pat. No. 6,014,931 discloses phase change adhesives, which include thermoplastic and hot melt materials. The entire teachings of U.S. Pat. No. 6,014,931 are incorporated by reference into this specification. Phase change adhesive 30 of this invention can also comprise an aliphatic resin or any other suitable adhesive and/or phase change material that has acceptable bonding properties.

Phase change adhesive 30 of this invention can form a composition that cooperates with or corresponds to properties of material forming heat shrinkable sleeve 20 or any other suitable shrink-fit sleeve. For example, phase change adhesive 30 can harden or soften at any desired temperature or temperature range by adjusting the composition materials and/or other design parameters of phase change adhesive 30.

In a disassembled state, sleeve 20 can have an inner diameter which is greater than an outer diameter of shaft 100. A tolerance or gap created by the difference in diameters can be used to slide or otherwise move sleeve 20 with respect to shaft 100, such as in a direction along longitudinal axis 101 of shaft 100. Once sleeve 20 is positioned, a temperature of phase change adhesive 30 can be changed so that phase change adhesive 30 flows into position and sleeve 20 can be heated to a shrunken state, such as shown in FIGS. 4 and 5. In the shrunken state, phase change adhesive 30 can provide sufficient holding or bonding strength, for example to resist a pulling force.

While in the foregoing specification this invention has been described in relation to certain preferred embodiments thereof, and many details have been set forth for purpose of illustration, it will be apparent to those skilled in the art that this invention is susceptible to additional embodiments and that certain of the details described herein can be varied considerably without departing from the basic principles of this invention.

What is claimed is:

1. In an apparatus for attaching a vane with respect to a shaft of at least one of an arrow and a bolt, wherein a sleeve mounted about an outer surface of the shaft, the improvement comprising: in an attached position of the vane with respect to the shaft a phase change adhesive positioned between and contacting at least a portion of an inner surface of the sleeve and at least a portion of the outer surface.

2. The apparatus according to claim 1, wherein said phase change adhesive forms a layer between said inner surface and said outer surface.

3. The apparatus according to claim 2, wherein said layer is positioned about a periphery of said outer surface.

4. The apparatus according to claim 1, wherein said phase change adhesive comprises an aliphatic resin.

5. The apparatus according to claim 1, wherein said phase change adhesive forms a plurality of contact areas separated from each other.

6. The apparatus according to claim 5, wherein each said contact area forms a band.

7. The apparatus according to claim 1, wherein the sleeve is of a shrink-it material.

8. The apparatus according to claim 1, wherein in a disassembled state the sleeve has an inner diameter greater than an outer diameter of the shaft.

9. The apparatus according to claim 1, wherein in said attached position the sleeve is in a shrunken state.

10. The apparatus according to claim 1, wherein a plurality of vanes are attached at an exterior surface of the sleeve.

11. An apparatus for attaching a vane with respect to a shaft of at least one of an arrow and a bolt, the apparatus comprising: a sleeve positionable over an outer surface of said shaft, said sleeve having an inner surface, in an attached position of said vane with respect to the shaft a phase change adhesive positioned between said sleeve and the shaft and contacting at least a portion of said inner surface and at least a portion of said outer surface.

12. The apparatus according to claim 11, wherein said phase change adhesive forms a layer between said inner surface and said outer surface.

13. The apparatus according to claim 12, wherein said layer is positioned about a periphery of said outer surface.

14. The apparatus according to claim 11, wherein said phase change adhesive comprises an aliphatic resin.

15. The apparatus according to claim 11, wherein said phase change adhesive forms a plurality of contact areas separated from each other.

16. The apparatus according to claim 15, wherein each said contact area forms a band.

17. The apparatus according to claim 11, wherein the sleeve is of a shrink-fit material.

18. The apparatus according to claim 11, wherein in a disassembled state said sleeve has an inner diameter greater than an outer diameter of said shaft.

19. The apparatus according to claim 11, wherein in said attached position said sleeve is in a shrunken state.

20. The apparatus according to claim 11, wherein a plurality of vanes are attached at an exterior surface of said sleeve.
